(19) United States
(12) Patent Application Publication
(10) Pub. No.: US 2009/0089073 A1
(43) Pub. Date: Apr. 2, 2009

(54) Contact management system through internet

(75) Inventor: Barry Rongsheng Su, El Morite, CA (US)

Correspondence Address: DAVID AND RAYMOND PATENT FIRM, 108 N. YNEZ AVE., SUITE 128, MONTEREY PARK, CA, 91754, US

(73) Assignee: Tyloon Inc.

(21) Appl. No.: 11/906,737

(22) Filed: Oct. 2, 2007

(51) Int. Cl. G06Q 10/00; G06F 17/30

(52) U.S. Cl. 705/1

(57) ABSTRACT

A contact management method includes the steps of providing an information center for a receiver to access through Internet; receiving a business portfolio in the information center, wherein the business portfolio contains information of a giver; receiving a personal code from the receiver in the information center; and verifying information of the giver in the business portfolio in responsive to the personal code. Therefore, the information center provides a communication platform to bond the relationship between the giver and the receiver after the exchange of the business card and verifies the giver by matching the information of giver on the business card with the information of the giver in the information center.

### BACKGROUND OF THE PRESENT INVENTION

1. Field of Invention

The present invention relates to a business management, and more particularly to a contact management system through Internet, wherein the contact management system not only provides business information in an electronic form but also verifies the business information to ensure the truth thereof.

2. Description of Related Arts

In order to provide business information, business card is considered as one of the major communication tools for an individual to memorize the business information. Accordingly, a business card is generally a pocket-sized card containing business information of a company or an individual, wherein people exchange their business card during formal introduction. The business card generally includes a giver's name with business title, a company name, and contact information including address, contact telephone number, and/or email address. However, such business card has several drawbacks.

The conventional business card contains black text printed on a white sheet. An improved business card may contain visual design to enhance the attention of the giver's information. However, the receiver may loss the business cards easily after he or she receive hundreds of business cards and put them in the card container. In addition, it is a hassle for the receiver to look for a particular giver's business card from hundreds of business cards.

Another major drawback of the business card is that when the giver changes the personal information, such as business title or telephone phone, he or she should make an updated business card. Therefore, the receiver may collect different business cards from the same giver such that the updated business card will be placed in the card container without removing the old business card therefrom.

Another major drawback of the business card is that the receiver is unable to verify whether the information on the business card is true or not. Therefore, it is a responsibility for the receiver to call the company to verify the giver's information. Otherwise, the receiver is hard to determine whether it is a fraud or not.

Even though the conventional business card has the above mentioned drawbacks, the exchange of business cards cannot be terminated. As a common social practice, people, such as a small business or freelancer, are extremely reliant on business card.

### SUMMARY OF THE PRESENT INVENTION

A main object of the present invention is to provide a contact management system and method through Internet, wherein the contact management system not only provides business information in an electronic form but also verifies the business information to ensure the truth thereof.

Another object of the present invention is to provide a contact management system and method through Internet, wherein a personal code is provided on the business card such that the receiver is able to input the personal code to an information center through Internet to verify the giver's information.

Another object of the present invention is to provide a contact management system and method through Internet, which allows the receiver to immediately identify the giver once the receiver communicatively links to the information center through Internet. Therefore, an accuracy and reliability of the giver's information stored in the information center with respect to the relevant company can be ensured.

Another object of the present invention is to provide a contact management system and method through Internet, which allows people to keep the tradition of exchanging of business cards as a common social practice in an information secured manner.

Another object of the present invention is to provide a contact management system and method through Internet, wherein the information of the business card is automatically stored in the information center such that the receiver is able to find the particular giver's information from the information center through Internet without accumulatively collecting all the business card.

Another object of the present invention is to provide a contact management system and method through Internet, wherein the card provider is able to update the information of the giver in the information center to keep the giver's information currently and to ensure the truth of the giver's information for the receiver so as to assist the receiver in making accurate decisions in the course of a wide variety of business dealings.

Another object of the present invention is to provide a contact management system and method through Internet, which also utilize electronic communication network for providing information, so as to allow widespread and convenient application of the present invention by a wide range of users.

Another object of the present invention is to provide a contact management system through Internet, which are easy to use and interactive in nature so as to facilitate widespread application of the present invention

These and other objectives, features, and advantages of the present invention will become apparent from the following detailed description, the accompanying drawings, and the appended claims.

### BRIEF DESCRIPTION OF THE DRAWINGS

FIG. 1 is a block diagram of a contact management system according to a preferred embodiment of the present invention.

FIG. 2 is a flow diagram of the contact management method for the portfolio provider according to the above preferred embodiment of the present invention.

FIG. 3 is a flow diagram of the contact management method for the service provider according to the above preferred embodiment of the present invention.

FIG. 4 is a flow diagram of the contact management method for the receiver according to the above preferred embodiment of the present invention.

### DETAILED DESCRIPTION OF THE PREFERRED EMBODIMENTS

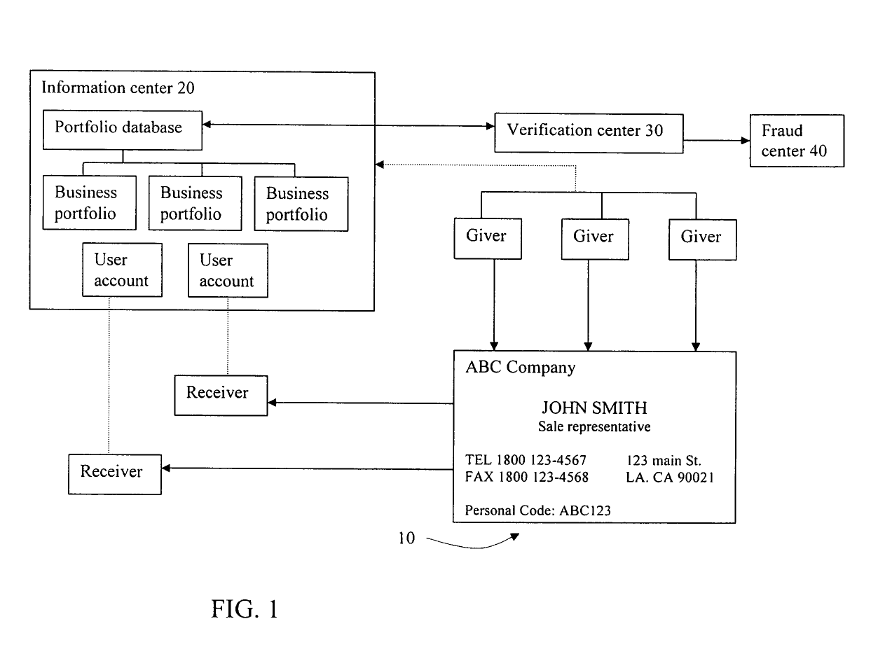

Referring to FIG. 1 of the drawings, a contact management system according to a preferred embodiment of the present invention is illustrated, wherein the system comprises a personal identification 10, an information center 20, and a verification center 30. According to the present invention, the contact management system is a platform to link among a giver and a receiver through Internet after a business card of the giver is given to the receiver.

The term “giver” refers to a person who gives the business card. The term “receiver” refers to a person who receives the business card. The term “service provider” refers to an individual, an association, an organization, or a company who provides the contact management system of the present invention. The term “portfolio provider” refers to an association, an organization or a company that the giver has relation to the staff member or the company.

The personal identification 10 contains a personal code provided on the business card of the giver. The personal code can be a sequence of numbers from 0 to 9, alphabetical letters from A to Z, and/or a combination of numbers and alphabetical letters. Accordingly, the business card generally includes a giver's name with business title, a company name, and contact information including address, contact telephone number, and/or email address. It is worth to mention that the business card can be an electronic business card (CD business card) that when the receiver accesses the electronic business card, the data therein will automatically access the information center 10 and input the personal code.

The information center 20 can be an Internet website available for the users including the portfolio provider, giver, and receiver, to enter anytime. The information center not only acts as an information provider for the users to search the information of the portfolio provider and giver but also is a central managing center for managing the information of the portfolio provider, giver, and receiver. The information center contains a portfolio database storing a plurality of business portfolios of different portfolio providers, wherein each of the business portfolios stores one or more information of the giver having relation to the corresponding portfolio provider.

The verification center 30 is communicatively linked to the information center, wherein the verification center 30 is arranged for the receiver verifying information of the giver stored in the business portfolio in responsive to the personal code. In other words, the information of the giver shown on the business card can be verified by matching with the information of the giver shown in the information center 10. Accordingly, when the personal code of the personal identification 10 is input to the information center 20, the verification center 30 will sort out the corresponding giver's information in the information center 20 such that the receiver is able to verify whether the giver's information on the business card matching with the giver's information in the information center 10.

The contact management system of the present invention further comprises a fraud center 40 that when the information of the giver on the business card does not match with that in the information center 20, the verification center 30 will report to the fraud center 40. In addition, the fraud center 40 will notice the corresponding portfolio provider regarding the false information of the giver.

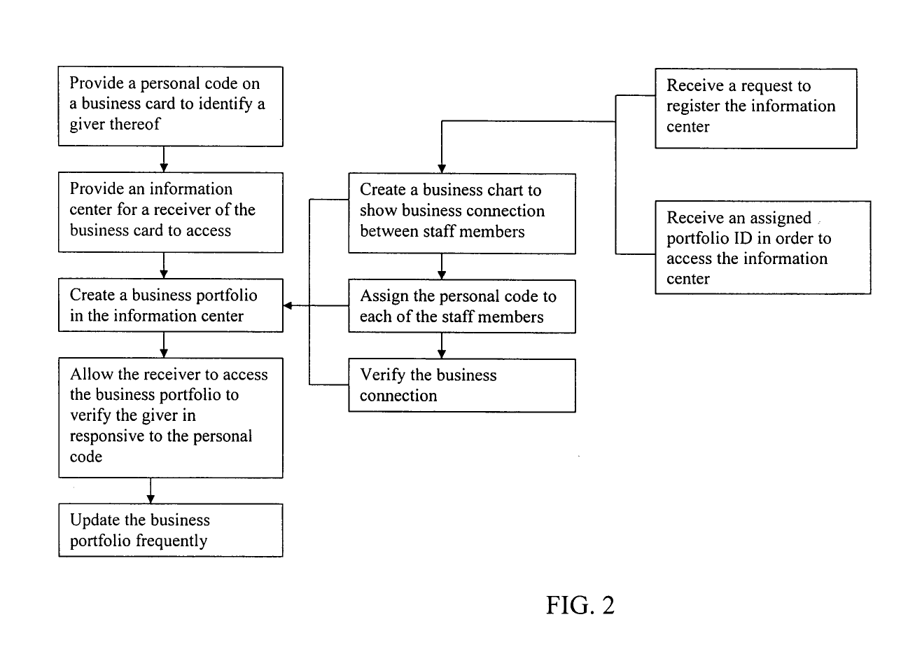

FIG. 2 illustrates the contact management method for the portfolio provider according to the above preferred embodiment of the present invention. As shown in FIG. 2, the method for the portfolio provider comprises the following steps.

(A1) Provide the personal code on the business card to identify the giver thereof.

(A2) Provide the information center 20 for the receiver of the business card to access through Internet.

(A3) Create the business portfolio in the information center 20, wherein the business portfolio contains information of the giver.

(A4) Allow the receiver to access the business portfolio to verify the giver in responsive to the personal code.

According to the preferred embodiment, the portfolio providers should register to the service provider as members thereof. Accordingly, the method further comprises the registering steps of:

receiving a request for each of the portfolio providers to register the service provider as the member thereof; and

receiving an assigned portfolio ID from the service provider such that the portfolio provider is adapted to access the information center 10 by inputting the corresponding portfolio ID.

Once the portfolio provider is registered, the information center 10 is allowed for the portfolio provider to access through Internet to create the business portfolio in the information center 10. In addition, the service provider will also provide the personal codes for the staff members of the portfolio provider respectively in the step (A1). Accordingly, the personal code is assigned for the particular staff member such that the personal codes have different configurations. Therefore, the personal code is printed on the business card of the giver at the time the business card is made. Alternatively, the personal code can be simply written by the giver.

In the step (A3), the method of the present invention further comprises the following steps.

(A3.1) Create the business chart to show business connection between staff members, wherein the giver is one of the staff members.

(A3.2) Assign the personal code to each of the staff members.

(A3.3) Verify the business connection to ensure an accuracy and reliability of the giver's information stored in the information center.

The portfolio provider is adapted to create the business portfolio in the information center 20 in the step (A3.1). The business portfolio contains a business chart to show business connection between the staff members. In other words, the portfolio provider creates the business chart to show business connection between the staff members as in the step (A3). Accordingly, the business chart also shows the management level of each of the staff members. The giver, which is one of the staff members in the business chart, provides the information to the portfolio provider to put the information in the business portfolio and in the business card.

It is worth to mention that since the giver's information is proved by the portfolio provider but not the giver, all information of the giver is already verified by the portfolio provider to ensure an accuracy and reliability of the giver's information stored in the information center in the step (A3.3).

After the receiver receives the business card from the giver, the receiver is able to access the information center 20 through Internet as in the step (A2). When the receiver input the personal code on the business card to the information center 20, the verification center 30 will verify the giver's information from the information center 20. In other words, the receiver is able to match the giver's information on the business card with the giver's information in the information center to verify the giver in the step (A4).

In addition, the service provider allows the portfolio provider to edit the information in the business portfolio. Accordingly, in the step (A3.3), information of the giver in the business connection is edited by the staff member with a higher management level than the giver to be edited. In other words, the staff member with a lower management level is prohibited to edit information of another staff member having a higher management level.

Alternatively, one or more assigned staff members of the portfolio provider is assigned as a management controller that only the management controller is allowed to access the corresponding business portfolio to edit the giver's information.

The portfolio provider is able to update the business portfolio frequently. In particularly, the portfolio provider is able to update the business portfolio any time, especially when the information of one of the staff member is changed.

Accordingly, a user account for the receiver is created to store the information of the business card of the giver. When the business portfolio is updated, the user account will automatically update for the receiver such that it is hassle-free for the receiver to change the information of the giver from the user account.

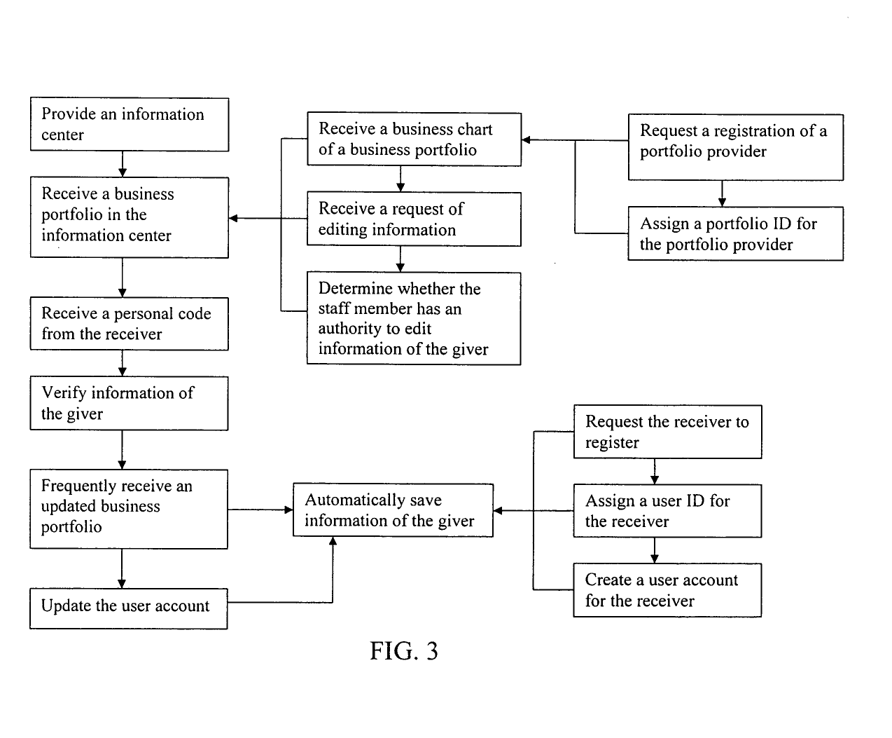

FIG. 3 is a flow diagram of the contact management method for the service provider according to the above preferred embodiment of the present invention. As shown in FIG. 3, the method for the service provider comprises the following steps.

(B1) Provide the information center 20 for the receiver to access through Internet.

(B2) Receive the business portfolio in the information center 20.

(B3) Receive the personal code from the receiver in the information center 20.

(B4) Verify information of the giver in the business portfolio in responsive to the personal code.

Accordingly, when the information of the giver on the business card does not match with that in the information center 20, the fraud center 40 will notice the corresponding portfolio provider regarding the false information of the giver.

According to the preferred embodiment, the portfolio providers should register to the service provider as members thereof. Accordingly, the method further comprises the service provider registering steps of:

requesting each of the portfolio providers to register the service provider as the member thereof, and

assigning a portfolio ID for the portfolio provider such that the portfolio provider is adapted to access the information center 20 by inputting the corresponding portfolio ID.

In the step (B.2) the method of the present invention further comprises the following steps.

(B2.1) Receive the business chart of the business portfolio to show the business connection between the staff members, wherein the personal code is assigned to each of the staff members as the giver.

(B2.2) Receive a request of editing information of the staff member.

(B2.3) Determine whether the staff member has an authority to edit information of the giver, wherein information of the giver is edited by the staff with the higher management level than the giver to be edited.

As it is mentioned above, once the portfolio provider is registered, the service provider will give an authorization for the portfolio provider to access the information center 20 and to edit the information of the giver.

Accordingly, the service provider will give an authorization to one or more assigned staff members of the portfolio provider as a management controller wherein only the management controller is allowed to access the corresponding business portfolio to edit the giver's information. Likewise, the service provider will determine the management level of the staff member whether he or she has an authorization to edit the information of the giver.

The service provider will also provides a suggested schedule for the portfolio provider to update the business portfolio frequently. However, the portfolio provider is able to update the business portfolio any time, especially when the information of one of the staff member is changed.

In addition, the receiver also should register to the service provider as members thereof. Accordingly, the method further comprises the receiver registering steps of:

requesting the receiver to register the service provider as the member thereof, and

assigning a user ID for the receiver such that the receiver is adapted to access the information center 10 by inputting the corresponding user ID.

Once the receiver is registered, the service provider will create the user account for the receiver to store the information of the business card of the giver. Accordingly, the user account will accumulatively collect and sort all the information from different givers such that when the user access the user account by the user ID through Internet, the user is able to search the particular giver. In other words, the receiver does not need to physically collect all the business cards and to search the particular business card of the giver one by one. In addition, the user account can be downloaded in the receiver's electronic device, such as desktop computer, laptop, or PDA, such that the receiver is able to look for the particular business card without accessing the information center 10.

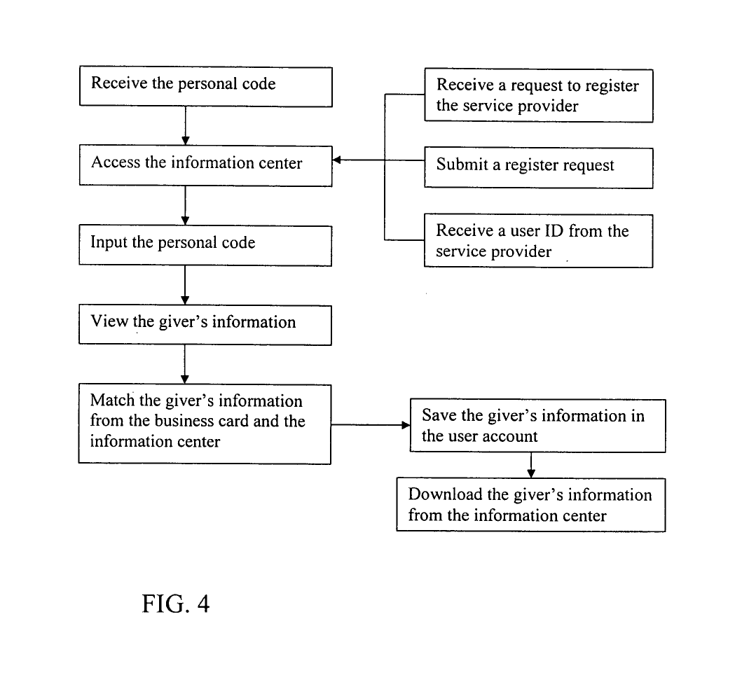

FIG. 4 is a flow diagram of the contact management method for the receiver according to the above preferred embodiment of the present invention. As shown in FIG. 3, the method for the receiver comprises the following steps.

(C1) Receive the personal code at the same when the receiver receives the business card from the giver.

(C2) Access the information center 20 through Internet.

(C3) Input the personal code to the information center to verify information the giver with respect to information on the business card.

Therefore, the receiver is able to view the information of the giver from the information center 20 and to match the giver's information from the business card and the information center so as to verify the information of the giver on the business card.

According to the preferred embodiment, the receiver should register to the service provider as members thereof. Accordingly, the method further comprises the portfolio provider registering steps of:

receiving a request to register the service provider as the member thereof;

submitting a register request, including the information of the receiver, to the service provider; and

receiving a user ID from the service provider such that the receiver is able to access the information center via the user ID.

Accordingly, once the receiver is registered, the service provider will create the user account for the receiver to store the information of the business card of the giver. Therefore, the receive is able to access the user account from the information center by the corresponding user ID to search the particular business card of the giver and to downward the user account to his or his the receiver's electronic device. It is worth to mention that the receiver is able to selectively save the information of the user in the user account and to delete the information of the giver therefrom at any time.

According to the preferred embodiment, after receiving the business card from the giver, the contact management system of the present invention not only provides a communication bond among the portfolio provider, the giver, and the receiver through the business card but also verifies the identification of the giver to build a trust among the portfolio provider, the giver, and the receiver.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A contact management method, comprising the steps of:
(a) providing a personal code on a business card to identify a giver thereof;
(b) providing an information center for a receiver of said business card to access through Internet;
(c) creating a business portfolio in said information center, wherein said business portfolio contains information of said giver; and
(d) allowing said receiver to access said business portfolio to verify said giver in responsive to said personal code.

2. The method, as recited in claim 1, wherein the step (c) further comprises the steps of:
(c.1) creating a business chart to show business connection between staff members, wherein said giver is one of said staff members;
(c.2) assigning said personal code to each of said staff members; and
(c.3) verifying said business connection to ensure an accuracy and reliability of said giver's information stored in said information center.

3. The method as recited in claim 2 wherein, in the step (c.3), information of said giver in said business connection is edited by said staff member with a higher management level than said giver to be edited.

4. The method, as recited in claim 1, further comprising a step of updating said business portfolio frequently.

5. The method, as recited in claim 3, further comprising a step of updating said business portfolio frequently.

6. The method, as recited in claim 1, further comprising the steps of:
receiving a request to register said information center as the member thereof; and
receiving an assigned portfolio ID in order to access said information center by inputting said corresponding portfolio ID.

7. The method, as recited in claim 5, further comprising the steps of:
receiving a request to register said information center as the member thereof; and
receiving an assigned portfolio ID in order to access said information center by inputting said corresponding portfolio ID.

8. A contact management method, comprising the steps of:
(a) providing an information center for a receiver to access through Internet;
(b) receiving a business portfolio in said information center, wherein said business portfolio contains information of a giver;
(c) receiving a personal code from said receiver in said information center; and
(d) verifying information of said giver in said business portfolio in responsive to said personal code.

9. The method, as recited in claim 8, wherein said personal code is provided on a business card for said giver to give to said receive.

10. The method, as recited in claim 8, further comprising a step of frequently receiving an updated business portfolio to replace said business portfolio in said information center.

11. The method, as recited in claim 9, further comprising a step of frequently receiving an updated business portfolio to replace said business portfolio in said information center.

12. The method, as recited in claim 8, wherein the step (b) further comprises the steps of:
(b.1) receiving a business chart of a business portfolio to show business connection between staff members, wherein said personal code is assigned to each of said staff members as said giver;
(b.2) receiving a request of editing information of said staff member; and
(b.3) determining whether said staff member has an authority to edit information of said giver, wherein information of said giver is edited by said staff with a higher management level than said giver to be edited.

13. The method, as recited in claim 11, wherein the step (b) further comprises the steps of:
(b.1) receiving a business chart of a business portfolio to show business connection between staff members, wherein said personal code is assigned to each of said staff members as said giver;
(b.2) receiving a request of editing information of said staff member; and
(b.3) determining whether said staff member has an authority to edit information of said giver, wherein information of said giver is edited by said staff with a higher management level than said giver to be edited.

14. The method, as recited in claim 8, further comprising the steps of:
requesting a registration of a portfolio provider who provides said business portfolio; and
assigning a portfolio ID for said portfolio provider such that said portfolio provider is adapted to access said business portfolio in said information center.

15. The method, as recited in claim 13, further comprising the steps of:
requesting a registration of a portfolio provider who provides said business portfolio; and
assigning a portfolio ID for said portfolio provider such that said portfolio provider is adapted to access said business portfolio in said information center.

16. The method, as recited in claim 8, further comprising a step of automatically saving information of said giver in said information center for said receiver.

17. The method, as recited in claim 15, further comprising a step of automatically saving information of said giver in said information center for said receiver.

18. The method, as recited in claim 16, further comprising the steps of:
requesting said receiver to register said information center as the member thereof;
assigning a user ID for said receiver such that said receiver is adapted to access said information center by inputting said corresponding user ID; and
creating a user account for said receiver to save information of said giver therein.

19. The method, as recited in claim 17, further comprising the steps of:
requesting said receiver to resister said information center as the member thereof;
assigning a user ID for said receiver such that said receiver is adapted to access said information center by inputting said corresponding user ID; and
creating a user account for said receiver to save information of said giver therein.

20. A contact management system, comprising:
a personal identification containing a personal code for providing on a business card of a giver to give to a receiver;
an information center adapted for said receiver accessing through Internet, wherein said information center contains a business portfolio storing information of said giver, and
a verification center communicatively linked to said information center for said receiver verifying information of said giver stored in said business portfolio in responsive to said personal code.

21. The contact management system, as recited in claim 20, wherein said information center further contains a portfolio database storing said business portfolios of different portfolio providers, wherein each of the business portfolios stores one or more information of said giver having relation to said corresponding portfolio provider.

22. The contact management system, as recited in claim 20, wherein said information center further contains a plurality of user accounts for said receivers respectively, wherein each of said user accounts contains information of said giver having relation to said receiver.

23. The contact management system, as recited in claim 21, wherein said information center further contains a plurality of user accounts for said receivers respectively, wherein each of said user accounts contains information of said giver having relation to said receiver.
